(19) United States
(12) Patent Application Publication
(10) Pub. No.: US 2016/0207366 A1
(43) Pub. Date: Jul. 21, 2016

(54) METHOD OF MODELLING A TIRE IN RUNNING CONDITIONS AT A DEFINED SPEED

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Jérémy BUISSON, Clermont-Ferrand (FR); Teddy VIRIN, Clermont-Ferrand (FR)

(21) Appl. No.: 14/909,500

(22) PCT Filed: Jul. 23, 2014
(86) PCT No.: PCT/FR2014/051916

§ 371 Date: Mar. 29, 2016

(30) Foreign Application Priority Data
Aug. 2, 2013 (FR) 1357693

(51) Int. Cl. B60C 99/00; G06F 17/50

(52) U.S. Cl. CPC B60C 99/006; G06F 17/5009; G06F 17/5095

(57) ABSTRACT

A method is provided for modelling a tire in running conditions at a defined speed. During running, the tire is subjected to a downward vehicle load (F_{z}) representing a vehicle and to a transverse thrust stress (F_{y}), and the tire is inclined with respect to a vertical direction by a camber angle (γ). The method includes modelling an overturning moment (Mx) exerted on the tire, in which the overturning moment (Mx) is a sum of at least:
a moment (Mx₁) produced by an offset of the vehicle load (F_{z}) by the camber angle (γ);
a moment (Mx₂) produced by the transverse thrust stress (F_{y});
a moment (Mx₃) produced by a ground reaction (F_{R}) under the vehicle load (F_{z}), with the ground reaction (F_{R}) being decentred from a reference point (C) of the tire by the transverse thrust stress (F_{y}).

### TECHNICAL FIELD

The present invention relates to a method of modelling a tire in running conditions at a defined speed and more precisely to a method comprising the modelling of the overturning moment exerted on the tire. The subject matter of the present invention is also a computer program product comprising program code instructions for implementing the mentioned modelling method. Furthermore, the present invention relates to a vehicle real-time stabilizing system comprising means for modelling the tire implementing the mentioned modelling method.

### PRIOR ART

Vehicle road behaviour implements complex phenomena, in particular at tire level.

Taking these phenomena into account in order to understand, analyse and simulate this road behaviour is essential to improve the latter.

In particular, to simulate vehicle drivability, the simulation tools require descriptive models for the behaviour of the tires.

Therefore, various quantities associated with the torsor of the tire or with the rolling geometry thereof are implemented for the simulation tools.

In particular, one of these quantities is the overturning moment Mx. This quantity is important for accounting for the bend reference actions of a vehicle and it can be applied to reaction strategies when faced with the risks of the vehicle rolling over. For example, the bend reference actions correspond to the vehicle load transfer and to the loaded radius variation associated with this load, to roll inducing to camber, and to the necessity for producing a stress via a drift angle.

Various methods comprising the modelling of the overturning moment Mx exerted on a tire in running conditions at a defined speed have already been proposed.

These methods apply various mathematical formulations to account for the progression of the overturning moment Mx of a tire.

Known from these mathematical formulations are the various versions of the so-called “magic formulae” formulations of H. B. Pacejka, the most widespread version of which is the MF-5.2 version (TNO, MF-Tire User Manual Version 5.2, 2001).

The MF-5.2 formulation most commonly used today describes the overturning moment Mx, as follows:

$$Mx = {R}_{0} \cdot {F}_{z} \cdot \{ {q}_{S \times 1} \cdot {λ}_{Vmx} + ( {q}_{S \times 2} \cdot γ \vert {q}_{S \times 3} \cdot \begin{matrix}{F}_{y} \\ {F}_{z 0}\end{matrix} ) \cdot {λ}_{Mx} \}$$

In the MF-5.2 formulation, R₀ is the free radius of the tire, F_{z} is the vertical load on the tire, q_{S×1} is the load-linearly dependent coefficient, λ_{Vmax} is the scaling factor associated with Q_{S×1}, Q_{S×2} is the camber-dependent coefficient, γ is the camber angle, sometimes called camber, q_{S×3} is the lateral stress-dependent coefficient, F_{y} is the transverse thrust stress exerted on the tire, F_{z0} is the tire reference load and λ_{Mx} is the overall scaling factor.

However, with use, it appears that the overturning moment Mx modelling carried out by using the MF-5.2 formulation lacks accuracy. Yet, the accuracy of the modelling of the overturning moment Mx exerted on a tire is extremely important for the manufacture of the tires since it contributes to reducing the risks of the vehicle rolling over. Moreover, this modelling can be incorporated into the vehicle automatic control devices and it is therefore important for the efficiency and the safety of the vehicle that this is as accurate as possible.

The aim of the present invention is to propose a method of modelling a tire in running conditions which comprises modelling of the overturning moment Mx exerted on the tire with improved accuracy.

### DESCRIPTION OF THE INVENTION

According to a first aspect of the invention, a method of modelling a tire in running conditions at a defined speed, the tire being subjected to a downward load representing a vehicle and to a transverse thrust stress and the tire being inclined with respect to the vertical by a camber angle, comprises the modelling of the overturning moment exerted on the tire wherein the overturning moment is the sum of at least:
a moment produced by the offset of the vehicle load by the camber angle;
a moment produced by the transverse thrust stress;
a moment produced by the reaction of the ground under the load, which reaction is decentred from the reference point by the transverse thrust stress.

The modelling of the overturning moment Mx exerted on a tire of the modelling method described above has an improved accuracy with regard to the accuracy set out by the MF-5.2 formulation of the prior art.

According to a first embodiment, since the tire has a drift angle and an inflation pressure, the moment produced by the reaction of the ground is a function of the vehicle load, the speed, the camber angle, the drift angle and the inflation pressure.

According to a second embodiment, the moment produced by the reaction of the ground is calculated by the following formula:

$${Mx}_{31} + {Mx}_{32} \times ( {F}_{z} - {Mx}_{33} ) \times γ + {F}_{z} \times arctan ( {Mx}_{34} \times δ \times {F}_{z} ) \times {Mx}_{35} \times ( 1 + {Mx}_{36} \times V ) \times ( 1 + \frac{{Mx}_{37} \times ( {Mx}_{38} - P )}{{Mx}_{38}} )$$

a moment produced by the offset of the vehicle load by the camber angle;
a moment produced by the transverse thrust stress;
a moment produced by the reaction of the ground under the load, which reaction is decentred from the reference point by the transverse thrust stress where Mx₃₁, Mx₃₂, Mx₃₃, Mx₃₄, Mx₃₅, Mx₃₆, Mx₃₇ and Mx₃₈ are predefined coefficients, F_{z} is the vehicle load, γ is the camber angle, δ is the drift angle, V is the speed and P is the inflation pressure.

According to a third embodiment, the coefficients Mx₃₁, Mx₃₂, Mx₃₃, Mx₃₄, Mx₃₅, Mx₃₆, Mx₃₇ and Mx₃₈ are defined during a preliminary step comprising:
a sub-step of bench measurements of the tire; then
a sub-step of iterative adjustment of the coefficients until the model reproduces the measurements to within a predefined error margin.

The modelling method of the invention can be used to define the behaviour of a vehicle comprising the tire modelled thereby, and preferably to define the behaviour of the vehicle when rolling over.

According to a second aspect of the invention, a computer program product downloadable from a communication network and/or recorded on a medium that can be read by computer and/or that can be executed by a processor comprises program code instructions for implementing the modelling method above.

According to a third aspect of the invention, a vehicle real-time stabilizing system comprising a tire comprises means for modelling the tire implementing the modelling method above.

### BRIEF DESCRIPTION OF THE FIGURES

The invention will be better understood upon reading the following description, given solely by way of example, and with reference to the appended figures wherein:

FIG. 1 shows the moment produced by the offset of the vehicle load by the camber angle;

FIG. 2 shows the moment produced by the transverse thrust effort;

FIG. 3 shows the moment produced by the reaction of the ground under the load, which reaction is decentred from the reference point by the transverse thrust stress; and

FIG. 4 shows a diagram for comparison between the measured overturning moment Mx and the overturning moment model Mx of the MF-5.2 formulation and the model of the overturning moment Mx used in the modelling method according to an embodiment of the invention.

### EMBODIMENTS

The present embodiment firstly relates to a method of modelling a tire in running conditions at a defined speed. The tire is subjected to a downward load F_{z} representing a vehicle and to a transverse thrust stress F_{y}. Furthermore, the tire is inclined in relation to the vertical by a camber angle γ. The method comprises the modelling of the overturning moment Mx exerted on the tire wherein the overturning moment Mx is the sum of at least:
a moment Mx₁ produced by the offset of the vehicle load F_{z} by the camber angle;
a moment Mx₂ produced by the transverse thrust stress;
a moment Mx₃ produced by the reaction of the ground F_{R} under the load F_{z}, which reaction is decentred from the reference point C by the transverse thrust stress F_{y}.

The modelling of the overturning moment Mx exerted on a tire of the modelling method described above has an improved accuracy with regard to the accuracy set out by the MF-5.2 formulation of the prior art due to the fact that the modelling of the overturning moment Mx better incorporates the effects of the moment Mx₃, namely the moment created by the decentred reaction of the ground, the effects of the internal temperature of the tire and of the surface temperature of the tire, as well as those of the speed of the vehicle, the inflation pressure of the tire and the transverse stress of the vehicle.

It should be noted that the modelling of the overturning moment Mx exerted on the tire is carried out under the typical conditions encountered on a vehicle comprising this tire. In particular, these typical conditions cover a large range of uses of the tire such as, for example, the running of the tire in a straight line or running at high speed on a track or the safety manoeuvres.

FIG. 1 illustrates the moment Mx₁ produced by the offset of the vehicle load by the camber angle. In particular, FIG. 1 illustrates the moment Mx₁ produced at the point of contact of the tire W with the ground and the load F_{z} exerted on the reference point C of the tire. Furthermore, FIG. 1 illustrates the camber angle γ which is the angle formed by the running plane of the tire with the vertical and the loaded radius Rₑ which is the distance between the reference point C of the tire and the point of contact of the tire w with the ground.

The moment Mx₁ produced by the offset of the vehicle load by the camber angle is calculated by the Formula F_{z}×Rₑ×tan(γ).

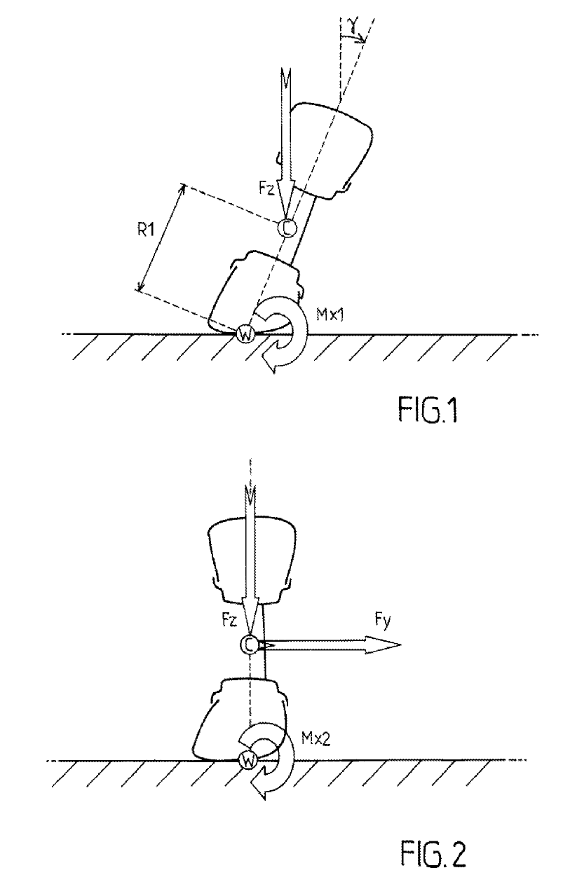

FIG. 2 illustrates the moment Mx₂ produced by the transverse thrust stress. In particular, FIG. 2 illustrates the moment Mx₂ produced at the point of contact of the tire W with the ground when a transverse thrust stress F_{y} is exerted on the reference point C of the tire. Furthermore, FIG. 2 illustrates the load F_{z} exerted on the reference point C of the tire.

The moment Mx₂ produced by the transverse thrust stress is calculated by the formula

$${F}_{z} \times \frac{{F}_{y}}{{K}_{yy}} ,$$

where F_{z} is the load exerted on the reference point C of the tire, F_{y} is the transverse thrust stress and K_{yy} is the lateral rigidity of the tire.

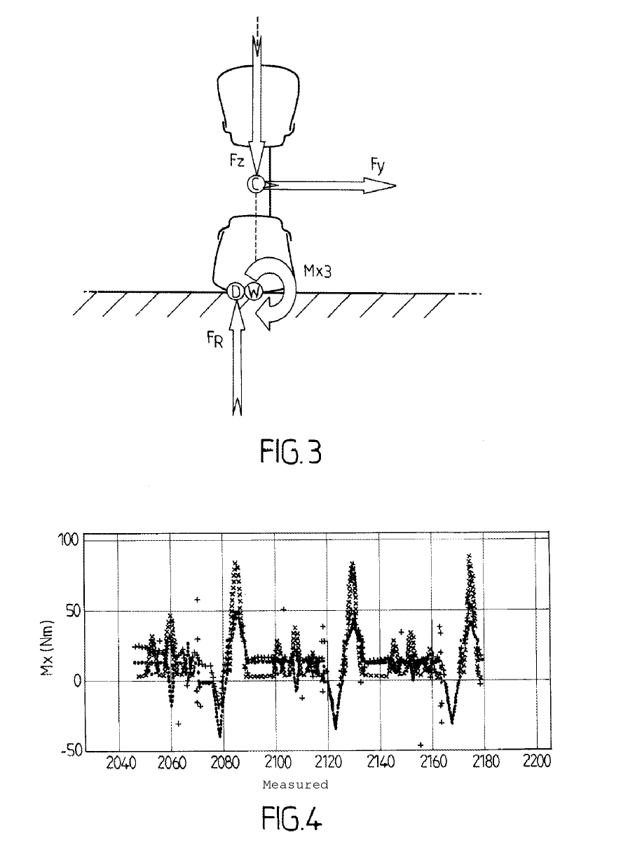

FIG. 3 illustrates the moment Mx₃ produced by the reaction of the ground F_{R} under the load F_{z}. It should be noted that the vertical component of the reaction of the ground F_{R} is decentred from the reference point C of the tire by the transverse thrust stress F_{y} exerted on the reference point C of the tire. FIG. 3 illustrates the point D of the tire on which the decentred reaction of the ground F_{R} is exerted.

Considering that the tire has a drift angle δ and an inflation pressure P, the moment Mx₃ is a function of the load F_{z} of the vehicle, the speed (V) of the vehicle, the camber angle γ, the drift angle δ and the inflation pressure P. It should be noted that the drift angle is the angle formed by the intersection of the plane of the ground with the wheel plane relative to the speed vector.

According to one feature, the moment Mx₃ produced by the reaction of the ground is calculated by the formula

$${Mx}_{31} + {Mx}_{32} \times ( {F}_{z} - {Mx}_{33} ) \times γ + {F}_{z} \times arctan ( {Mx}_{34} \times δ \times {F}_{z} ) \times {Mx}_{35} \times ( 1 + {Mx}_{36} \times V ) \times ( 1 + \frac{{Mx}_{37} \times ( {Mx}_{38} - P )}{{Mx}_{38}} )$$

where Mx₃₁, Mx₃₂, Mx₃₃, Mx₃₄, Mx₃₅, Mx₃₆, Mx₃₇ and Mx₃₈ are predefined coefficients, F_{z} is the vehicle load, γ is the camber angle, δ is the drift angle, V is the speed and P is the inflation pressure.

According to one feature, the coefficients Mx₃₁, Mx₃₂, Mx₃₃, Mx₃₄, Mx₃₅, Mx₃₆, Mx₃₇ and Mx₃₈ are defined during a preliminary step of the modelling method comprising a step of bench measurements (for example a planar ground roller) of said tire and a sub-step of iterative adjustment of the coefficients until the model reproduces the measurements to within a predefined error margin. Performing the measurements on a bench and iteratively adjusting the coefficients of a formula in order to calculate them are known to a person skilled in the art. Furthermore, it should be noted that, to optimize the coefficients Mx₃₁, Mx₃₂, Mx₃₃, Mx₃₄, Mx₃₅, Mx₃₆, Mx₃₇ and Mx₃₈, a successive iteration Levenberg-Marquardt or SQP (Sequential Quadratic Programming) type optimization algorithm can be used. These optimization algorithms are well known to a person skilled in the art.

FIG. 4 illustrates a diagram for comparison between the overturning moment Mx measured on a bench, the overturning moment model Mx of the MF-5.2 formulation mentioned in the prior art above and the model of the overturning moment Mx used in the modelling method described above.

The improvement provided by the model of the overturning moment Mx used in the modelling method described above, compared to the MF-5.2 formulation, is visible. In particular, as illustrated in FIG. 4, the tracings in dotted lines corresponding to the overturning moment Mx calculated by the method described above are closer to the star tracings corresponding to the overturning moment Mx measured on the bench compared to the “x” tracing corresponding to the overturning moment Mx calculated by the MF-5.2 formulation. Therefore, it is clear that the model of the overturning moment Mx of the invention has an improved accuracy compared to the MF-5.2 formulation.

The modelling method of the invention can be used to define the behaviour of a vehicle comprising the tire modelled thereby.

Particularly, the described modelling method can be used to define the behaviour of the vehicle when rolling over.

In an embodiment, the method is implemented by a computer program product that can be downloaded from a communication network and/or recorded on a medium that can be read by computer and/or executed by a processor, comprising program code instructions.

Furthermore, the method can be incorporated into a vehicle real-time stabilizing system comprising a tire modelled as described above. Therefore, the driving assistance system can more accurately define the rollover moment and, therefore, more effectively implement anti-rollover measures.

1-7. (canceled)

8: A method of modelling a tire in running conditions at a defined speed, the tire being subjected to a downward vehicle load (F_{z}) representing a vehicle and to a transverse thrust stress (F_{y}), and the tire being inclined with respect to a vertical direction by a camber angle (γ), the method comprising the steps of:
calculating a moment (Mx₃) produced by a ground reaction (F_{R}) of the tire under the vehicle load (F_{z}); and
modelling an overturning moment (Mx) exerted on the tire as a sum of at least:
a moment (Mx₁) produced by an offset of the vehicle load (F_{z}) by the camber angle (γ),
a moment (Mx₂) produced by the transverse thrust stress (F_{y}), and
the moment (Mx₃) produced by the ground reaction (F_{R}) of the tire under the vehicle load (F_{z}),
wherein the ground reaction (F_{R}) of the tire is decentered from a reference point (C) of the tire by the transverse thrust stress (F_{y}), and
wherein, in the calculating step, the moment (Mx₃) is calculated by a formula having a form of:
$${Mx}_{31} + {Mx}_{32} \times ( {F}_{z} - {Mx}_{33} ) \times γ + {F}_{z} \times arctan ( {Mx}_{34} \times δ \times {F}_{z} ) \times {Mx}_{35} \times ( 1 + {Mx}_{36} \times V ) \times ( 1 + \frac{{Mx}_{37} \times ( {Mx}_{38} - P )}{{Mx}_{38}} ) ,$$
where Mx₃₁, Mx₃₂, Mx₃₃, Mx₃₄, Mx₃₅, Mx₃₆, Mx₃₇ and Mx₃₈ are predefined coefficients, F_{z} is the vehicle load, γ is the camber angle, δ is a drift angle, V is a speed, and P is an inflation pressure.

9: The method according to claim 8,
wherein the drift angle (δ) and the inflation pressure (P) are quantities corresponding to the tire, and
wherein the moment (Mx₃) is a function of the vehicle load (F_{z}), the speed (V), the camber angle (γ), the drift angle (δ), and the inflation pressure (P).

10: The method according to claim 8, wherein the coefficients Mx₃₁, Mx₃₁, Mx₃₂, Mx₃₃, Mx₃₄, Mx₃₅, Mx₃₆, Mx₃₇ and Mx₃₈ are predefined during a preliminary step that includes:
performing bench measurements of the tire, and then
iteratively adjusting the coefficients until a model reproduces the bench measurements to within a predefined error margin.

11: The method according to claim 8, wherein the method is used to define a behaviour of a vehicle equipped with the tire.

12: The method according to claim 11, wherein the behaviour of the vehicle when rolling over is defined.

13: A computer-readable storage medium storing a program that, when read by a computer and executed by a computer processor, performs a method of modelling a tire in running conditions at a defined speed, the tire being subjected to a downward vehicle load (F_{z}) representing a vehicle and to a transverse thrust stress (F_{y}), and the tire being inclined with respect to a vertical direction by a camber angle (γ), the method comprising steps of:
calculating a moment (Mx₃) produced by a ground reaction (F_{R}) of the tire under the vehicle load (F_{z}); and
modelling an overturning moment (Mx) exerted on the tire as a sum of at least:
a moment (Mx₁) produced by an offset of the vehicle load (F_{z}) by the camber angle (γ),
a moment (Mx₂) produced by the transverse thrust stress (F_{y}), and
the moment (Mx₃) produced by the ground reaction (F_{R}) of the tire under the vehicle load (F_{z}),
wherein the ground reaction (F_{R}) of the tire is decentered from a reference point (C) of the tire by the transverse thrust stress (F_{y}), and
wherein, in the calculating step, the moment (Mx₃) is calculated by a formula having a form of:
$${Mx}_{31} + {Mx}_{32} \times ( {F}_{z} - {Mx}_{33} ) \times γ + {F}_{z} \times arctan ( {Mx}_{34} \times δ \times {F}_{z} ) \times {Mx}_{35} \times ( 1 + {Mx}_{36} \times V ) \times ( 1 + \frac{{Mx}_{37} \times ( {Mx}_{38} - P )}{{Mx}_{38}} ) ,$$
where Mx₃₁, Mx₃₂, Mx₃₃, Mx₃₄, Mx₃₅, Mx₃₆, Mx₃₇ and Mx₃₈ are predefined coefficients, F_{z} is the vehicle load, γ is the camber angle, δ is a drift angle, V is a speed, and P is an inflation pressure.

14: A real-time stabilizing system for a vehicle, the system comprising:
a tire; and
a processor programmed to model the tire in running conditions at a defined speed, with the tire being subjected to a downward vehicle load (F_{z}) and to a transverse thrust stress (F_{y}), and with the tire being inclined with respect to a vertical direction by a camber angle (γ),
wherein the processor calculates a moment (Mx₃) produced by a ground reaction (F_{R}) of the tire under the vehicle load (F_{z}), and models an overturning moment (Mx) exerted on the tire as a sum of at least:
a moment (Mx₁) produced by an offset of the vehicle load (F_{z}) by the camber angle (γ),
a moment (Mx₂) produced by the transverse thrust stress (F_{y}), and
the moment (Mx₃) produced by the ground reaction (F_{R}) of the tire under the vehicle load (F_{z}),
wherein the ground reaction (F_{R}) of the tire is decentered from a reference point (C) of the tire by the transverse thrust stress (F_{y}), and
wherein the moment (Mx₃) is calculated by a formula in which:
$${Mx}_{31} + {Mx}_{32} \times ( {F}_{z} - {Mx}_{33} ) \times γ + {F}_{z} \times arctan ( {Mx}_{34} \times δ \times {F}_{z} ) \times {Mx}_{35} \times ( 1 + {Mx}_{36} \times V ) \times ( 1 + \frac{{Mx}_{37} \times ( {Mx}_{38} - P )}{{Mx}_{38}} ) ,$$
where Mx₃₁, Mx₃₂, Mx₃₃, Mx₃₄, Mx₃₅, Mx₃₆, Mx₃₇ and Mx₃₈ are predefined coefficients; F_{z} is the vehicle load, γ is the camber angle, δ is a drift angle, V is a speed, and P is an inflation pressure.
